(19) United States
(12) Patent Application Publication
(10) Pub. No.: US 2015/0336468 A1
(43) Pub. Date: Nov. 26, 2015

(54) POWER SUPPLY SYSTEM FOR VEHICLE, VEHICLE COMPRISING THE SAME, AND METHOD FOR CONTROLLING POWER SUPPLY SYSTEM FOR VEHICLE

(71) Applicant: Yoshinobu SUGIYAMA, Toyota-shi, Aichi (JP)

(72) Inventor: Yoshinobu SUGIYAMA, Toyota-shi (JP)

(73) Assignee: TOYOTA JIDOSHA KABUSHIKI KAISHA, Toyota-shi, Aichi-ken (JP)

(21) Appl. No.: 14/646,269

(22) PCT Filed: Dec. 25, 2012
(86) PCT No.: PCT/JP2012/083411

§ 371 Date: May 20, 2015

(51) Int. Cl. B60L 11/18

(52) U.S. Cl. CPC B60L 11/1864; B60L 11/1811; B60L 11/1861; B60L 11/1859

(57) ABSTRACT

A power supply system for a vehicle includes a main battery, an auxiliary battery, a DC/DC converter, and a control device. The DC/DC converter is configured to be capable of performing bidirectional power conversion between the main battery and the auxiliary battery. After a predetermined time has passed from the input of a stop command for the power supply system, the control device executes charge/discharge control to cause one of the main battery and the auxiliary battery to be charged and the other of the main battery and the auxiliary battery to be discharged by a DC/DC converter, based on a result of comparison between a charged state of the main battery and a charged state of the auxiliary battery.

### TECHNICAL FIELD

This invention relates to a power supply system for a vehicle, a vehicle including the same, and a method for controlling the power supply system for a vehicle. More specifically, the invention relates to a power supply system for a vehicle including a plurality of power storage devices, a vehicle including the power supply system for a vehicle, and a method for controlling the power supply system for a vehicle.

### BACKGROUND ART

Japanese Patent Laying-Open No. 2007-137275 (PTD 1) discloses a hybrid vehicle on which a high-voltage battery and a low-voltage battery are mounted. This hybrid vehicle includes a voltage converter that converts the voltage of the high-voltage battery into a voltage for charging the low-voltage battery. While the vehicle is parked, the low-voltage battery is charged with the electric power received from the high-voltage battery. Consequently, the vehicle can be prevented from being unable to be started due to the low-voltage battery going dead (see PTD 1).

### CITATION LIST

### Patent Document

PTD 1: Japanese Patent Laying-Open No. 2007-137275

PTD 2: Japanese Patent Laying-Open No. 2010-172138

PTD 3: Japanese Patent Laying-Open No. 2006-304393

### SUMMARY OF INVENTION

### Technical Problem

If, however, the electric power stored in the high-voltage battery decreases while the vehicle is parked, electric power for running cannot be supplied sometimes. In this case, the vehicle may not be drivable even though electric power is stored in the low-voltage battery. If, therefore, any of the high-voltage battery and the low-voltage battery has gone dead, the vehicle will be put in a state that is not drivable.

Accordingly, it is an object of this invention to extend a parking period during which a vehicle can be in a drivable state, in a vehicle on which a power supply system that includes a power storage device for running and an auxiliary power storage device is mounted.

### Solution to Problem

According to one aspect of this invention, a power supply system for a vehicle includes a first power storage device, a second power storage device, a converter, and a control device. The first power storage device stores electric power for running. The second power storage device stores electric power to be supplied to an auxiliary load of the vehicle. The converter is capable of executing bidirectional power conversion between the first power storage device and the second power storage device. The control device is configured to execute charge/discharge control, after a predetermined time has passed from input of a stop command for the power supply system, to cause one of the first power storage device and the second power storage device to be charged and the other of the first power storage device and the second power storage device to be discharged by the converter, based on a result of comparison between a charged state of the first power storage device and a charged state of the second power storage device.

Preferably, during the execution of the charge/discharge control, the control device controls the converter to reduce a difference between a state amount representing the charged state of the first power storage device and a state amount representing the charged state of the second power storage device.

Preferably, the charged state of the first power storage device corresponds to a period during which the first power storage device can be left unused, depending on the state amount representing the charged state of the first power storage device. The charged state of the second power storage device corresponds to a period during which the second power storage device can be left unused, depending on the state amount representing the charged state of the second power storage device.

Preferably, the control device completes the charge/discharge control when the difference between the state amount representing the charged state of the first power storage device and the state amount representing the charged state of the second power storage device falls below a predetermined value.

Preferably, during the execution of the charge/discharge control, the control device interrupts the charge/discharge control when a prescribed condition is satisfied.

Preferably, the prescribed condition is satisfied when at least one of opening of a door, opening of an engine hood, release of a door lock, depression of a brake pedal, an auto-alarm system being set in an alarmed state, and approaching of a remote key, is detected.

Preferably, when the charge/discharge control is interrupted, the control device calculates the period during which the first power storage device can be left unused and the period during which the second power storage device can be left unused, and based on a result of comparison between the predetermined period and each of the period during which the first power storage device can be left unused and the period during which the second power storage device can be left unused, the control device sets a start time for the charge/discharge control, so as to prevent electric power stored in the first power storage device and electric power stored in the second power storage device from running out until the charge/discharge control takes place next time.

According to another aspect of this invention, a vehicle includes any of the power supply systems described above.

According to still another aspect of this invention, a power supply system for a vehicle includes a first power storage device, a second power storage device, and a converter. The first power storage device stores electric power for running. The second power storage device stores electric power to be supplied to an auxiliary load of the vehicle. The converter is capable of executing bidirectional power conversion between the first power storage device and the second power storage device. A method for controlling the power supply system includes the step of executing charge/discharge control, after a predetermined time has passed from input of a stop command for the power supply system for a vehicle, to cause one of the first power storage device and the second power storage device to be charged and the other of the first power storage device and the second power storage device to be discharged by the converter, based on a result of comparison between a charged state of the first power storage device and a charged state of the second power storage device.

Preferably, the step of executing the charge/discharge control includes the step of, during the execution of the charge/discharge control, controlling the converter to reduce a difference between a state amount representing the charged state of the first power storage device and a state amount representing the charged state of the second power storage device.

Preferably, the charged state of the first power storage device corresponds to a period during which the first power storage device can be left unused, depending on the state amount representing the charged state of the first power storage device. The charged state of the second power storage device corresponds to a period during which the second power storage device can be left unused, depending on the state amount representing the charged state of the second power storage device.

Preferably, the step of executing the charge/discharge control includes the step of completing the charge/discharge control when the difference between the state amount representing the charged state of the first power storage device and the state amount representing the charged state of the second power storage device falls below a predetermined value.

Preferably, the step of executing the charge/discharge control includes the step of, during the execution of the charge/discharge control, interrupting the charge/discharge control when a prescribed condition is satisfied.

Preferably, the above-described prescribed condition is satisfied when at least one of opening of a door, opening of an engine hood, release of a door lock, depression of a brake pedal, an auto-alarm system being set in an alarmed state, and approaching of a remote key, is detected.

Preferably, the step of executing the charge/discharge control includes the steps of: when the charge/discharge control is interrupted, calculating the period during which the first power storage device can be left unused and the period during which the second power storage device can be left unused; and based on a result of comparison between the period during which the first power storage device can be left unused and the period during which the second power storage device can be left unused, setting a start time for the charge/discharge control, so as to prevent electric power stored in the first power storage device and electric power stored in the second power storage device from running out until the charge/discharge control takes place next time.

### Advantageous Effects of Invention

In this invention, after a predetermined time has passed from input of a stop command for the power supply system for a vehicle, the charge/discharge control is executed to cause one of the first power storage device and the second power storage device to be charged and the other of the first power storage device and the second power storage device to be discharged by the converter, based on a result of comparison between a charged state of the first power storage device and a charged state of the second power storage device. In this way, the distribution of electric power stored in the first power storage device and the second power storage device is adjusted, which allows only one of electric power stored in the first power storage device and electric power stored in the second power storage device to be prevented from running out. According to this invention, therefore, in a vehicle on which a power supply system that includes a power storage device for running and an auxiliary power storage device is mounted, a parking period during which the vehicle can be in a drivable state can be extended.

### BRIEF DESCRIPTION OF DRAWINGS

FIG. 1 is an overall block diagram of a vehicle on which a power supply system according to an embodiment of this invention is mounted.

FIG. 2 is a diagram illustrating the configuration of a control device illustrated in FIG. 1.

FIG. 3 is a flowchart illustrating a processing procedure of charge/discharge control executed by the control device illustrated in FIG. 1.

FIG. 4 is a flowchart illustrating a processing procedure of charge/discharge control executed by the control device illustrated in FIG. 1.

FIG. 5 is a flowchart for illustrating details of processing for setting a subsequent timer start condition in step S15 in FIG. 4.

### DESCRIPTION OF EMBODIMENTS

Embodiments of the present invention will be described below in detail with reference to the drawings, in which the same or corresponding parts are indicated by the same reference characters, and the description thereof will not be repeated.

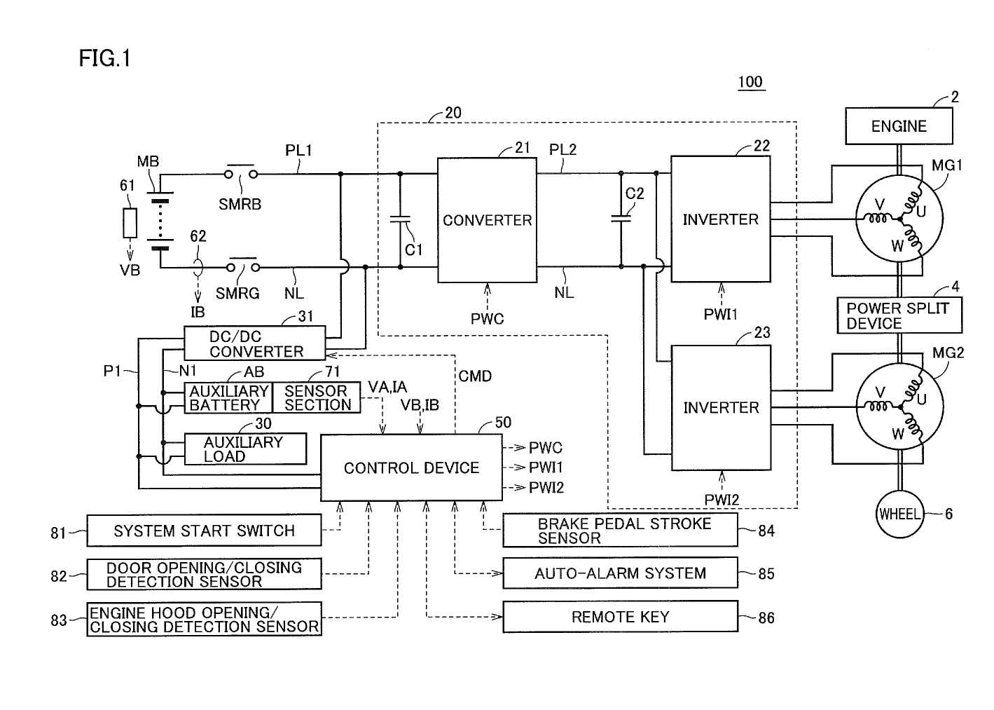

FIG. 1 is an overall block diagram of a vehicle on which a power supply system according to an embodiment of this invention is mounted. With reference to FIG. 1, a vehicle 100 includes an engine 2, motor generators MG1, MG2, a power split device 4, a wheel 6, a main battery MB, system main relays SMRB, SMRG, and a PCU (Power Control Unit) 20. Vehicle 100 further includes an auxiliary battery AB, an auxiliary load 30, a DC/DC converter 31, a control device 50, a voltage sensor 61, a current sensor 62, and a sensor section 71. Vehicle 100 further includes a system start switch 81, a door opening/closing detection sensor 82, an engine hood opening/closing detection sensor 83, a brake pedal stroke sensor 84, an auto-alarm system 85, and a remote key 86.

Vehicle 100 runs using engine 2 and motor generator MG2 as a power source. A driving force generated by engine 2 and motor generator MG2 is transmitted to wheel 6.

Engine 2 is an internal combustion engine such as a gasoline engine, a diesel engine, or the like, which burns a fuel and outputs power. Engine 2 is configured such that its operating conditions such as a throttle position (amount of intake air), an amount of fuel supply, an ignition timing, and the like can be electrically controlled by a signal from control device 50.

Each of motor generators MG1, MG2 is an AC rotating electric machine, for example, a three-phase AC synchronous motor. Motor generator MG1 is used as a power generator driven by engine 2, and is also used as a rotating electric machine that can start engine 2. Electric power obtained by power generation of motor generator MG1 can be used to charge main battery MB, and can also be used to drive motor generator MG2. Motor generator MG2 is used primarily as a rotating electric machine that drives wheel 6 of vehicle 100.

Power split device 4 includes a planetary gear mechanism having the three rotation shafts, i.e., a sun gear, a carrier, and a ring gear, for example. The sun gear is coupled to the rotating shaft of motor generator MG1. The carrier is coupled to the crankshaft of engine 2. The ring gear is coupled to the driving shaft. Power split device 4 splits the driving force of engine 2 into power for transmission to the rotation shaft of motor generator MG1 and power for transmission to the driving shaft. The driving shaft transmits the driving force to wheel 6. The driving shaft is also coupled to the rotating shaft of motor generator MG2.

Main battery MB is a DC power supply that is chargeable and dischargeable, and is formed by a secondary battery such as a nickel-metal hydride battery, a lithium-ion battery, or the like, or by a capacitor, for example. Main battery MB supplies electric power to PCU 20, and during power regeneration, main battery MB is charged with electric power from PCU 20. It is noted here that the electric power stored in main battery MB is used to drive motor generator MG1, for starting engine 2. Therefore, if the electric power stored in main battery MB decreases, starting of engine 2 becomes difficult. The electric power stored in main battery MB can also be used to charge auxiliary battery AB by DC/DC converter 31.

System main relays SMRB, SMRG switch conduction/non-conduction between main battery MB, and PCU 20 and DC/DC converter 31, based on a signal from control device 50.

PCU 20 includes a converter 21, inverters 22, 23, and capacitors C1, C2. Converter 21 performs power conversion between a positive electrode line PL1 and a negative electrode line NL, and between a positive electrode line PL2 and a negative electrode line NL, based on a control signal PWC from control device 50.

Inverters 22, 23, which are arranged in parallel, are connected to positive electrode line PL2 and negative electrode line NL. Inverter 22 converts DC electric power supplied from converter 21 into AC electric power, based on a signal PWI 1 from control device 50, to drive motor generator MG1. Inverter 23 converts DC electric power supplied from converter 21 into AC electric power, based on a signal PWI 2 from control device 50, to drive motor generator MG2.

Capacitor C1 is provided between positive electrode line PL1 and negative electrode line NL to reduce voltage fluctuations between positive electrode line PL1 and negative electrode line NL. Capacitor C2 is provided between positive electrode line PL2 and negative electrode line NL to reduce voltage fluctuations between positive electrode line PL2 and negative electrode line NL.

Auxiliary load 30 is an electrical device that operates with electric power supplied from auxiliary battery AB. Auxiliary battery AB is a power storage element that stores electric power to be supplied to auxiliary load 30 and control device 50. Auxiliary battery AB is configured to output a lower voltage than that of main battery MB. Auxiliary battery AB is charged by DC/DC converter 31. It is noted here that because auxiliary battery AB supplies electric power for operation of control device 50, if the electric power stored in auxiliary battery AB decreases, starting of vehicle 100 becomes difficult.

DC/DC converter 31 is configured to be capable of performing bidirectional power conversion between main battery MB and auxiliary battery AB. DC/DC converter 31 operates based on a signal CMD from control device 50. When auxiliary battery AB is to be charged, DC/DC converter 31 charges auxiliary battery AB with electric power supplied from main battery MB. On the other hand, when main battery MB is to be charged, DC/DC converter 31 charges main battery MB with electric power supplied from auxiliary battery AB.

Voltage sensor 61 detects a voltage VB across the terminals of main battery MB for output to control device 50. Current sensor 62 detects a current IB flowing through main battery MB for output to control device 50. Sensor section 71 detects a voltage VA across the terminals of auxiliary battery AB and a current IA flowing through auxiliary battery AB for output to control device 50.

Control device 50 includes a CPU (Central Processing Unit) storage device and an input/output buffer, both not shown in FIG. 1. Control device 50 inputs signals from various sensors and the like, and outputs control signals to various devices, and also controls vehicle 100 and various devices. It is noted that such control can be processed not only by software, but also by dedicated hardware (electronic circuit) constructed therefor.

Control device 50 receives voltage VB from voltage sensor 61, and receives current IB from current sensor 62. Control device 50 calculates an SOC (State Of Charge) representing a charged state of main battery MB, based on voltage VB and current IB. Control device 50 receives voltage VA and current IA from sensor section 71. Control device 50 calculates an SOC representing a charged state of auxiliary battery AB, based on voltage VA and current IA.

Control device 50 receives a signal from system start switch 81, door opening/closing detection sensor 82, engine hood opening/closing detection sensor 83, brake pedal stroke sensor 84, auto-alarm system 85, or remote key 86, and determines the state of vehicle 100.

Control device 50 generates a control signal for controlling PCU 20 and DC/DC converter 31 for output. It is noted here that control device 50 operates with electric power supplied from auxiliary battery AB. During the operation of vehicle 100, the electric power stored in auxiliary battery AB is kept from decreasing. In the case, however, where vehicle 100 is parked over a long period, for example, electric power stored in auxiliary battery AB gradually decreases due to self-discharge or the like.

In order to prevent this, while vehicle 100 is parked, control device 50 may activate DC/DC converter 31 to execute charging of electric power from main battery MB into auxiliary battery AB, so that the electric power stored in auxiliary battery AB does not fall below an amount required for starting vehicle 100. For example, every time a parking time lasts for a prescribed time (10 days, for example), auxiliary battery AB may be automatically charged for a prescribed time (10 minutes, for example).

In the case, however, where the electric power stored in main battery MB is low even though sufficient electric power is stored in auxiliary battery AB, vehicle 100 cannot be put in a drivable state sometimes. Specifically, it is necessary to drive motor generator MG1 for starting engine 2. Because motor generator MG1 operates with electric power from main battery MB, if the electric power stored in main battery MB decreases, starting of engine 2 becomes difficult. As described above, if any of main battery MB and auxiliary battery AB goes dead, vehicle 100 cannot be put in a drivable state.

In this embodiment, after a prescribed time has passed from the input of a stop command for the power supply system for the vehicle, control device 50 executes charge/discharge control to cause one of main battery MB and auxiliary battery AB to be charged and the other of main battery MB and auxiliary battery AB to be discharged, based on a result of comparison between the number of days during which main battery MB can be left unused and the number of days during which auxiliary battery AB can be left unused. By adjusting the distribution of electric power stored in main battery MB and auxiliary battery AB as described above, it is possible to prevent only one of main battery MB and auxiliary battery AB from going dead. This charge/discharge control will be hereinafter described in detail.

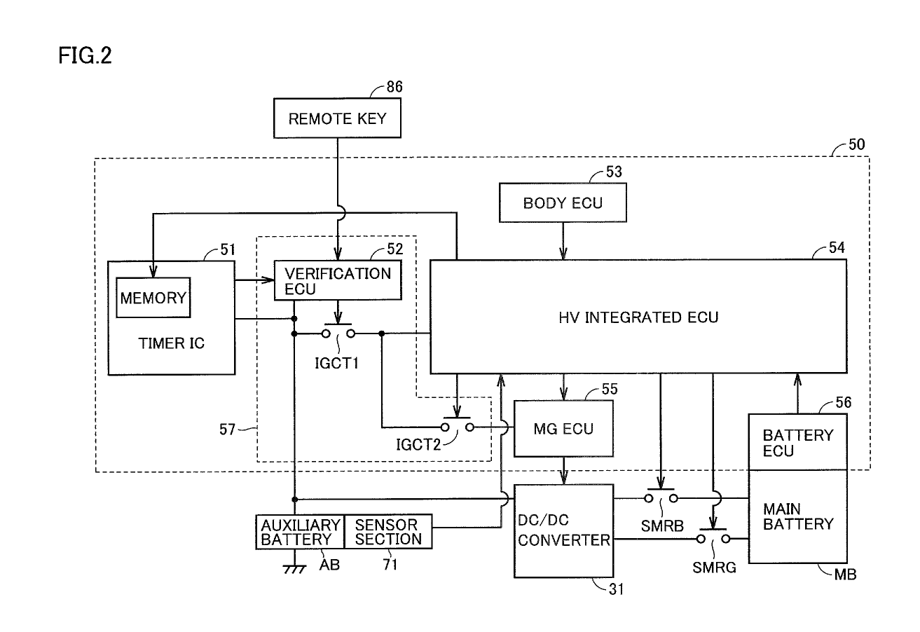

FIG. 2 is a diagram illustrating in more detail the configuration of control device 50 illustrated in FIG. 1. With reference to FIG. 2, control device 50 includes a timer IC (Integrated Circuit) 51, a verification ECU (Electronic Control Unit) 52, a body ECU 53, an HV integrated ECU 54, an MG-ECU 55, a battery ECU 56, and switches IGCT1, IGCT2.

Control device 50 is provided with a power supply voltage from auxiliary battery AB. While this power supply voltage is constantly supplied to timer IC 51 and verification ECU 52, it is supplied to HV integrated ECU 54 and MG-ECU 55 by way of switches IGCT1 and IGCT2, respectively. Each of switches IGCT1 and IGCT2 may be implemented using a mechanical means such as a relay or the like, or using a semiconductor device such as a transistor or the like.

Verification EUC 52 and switches IGCT1, IGCT2 operate as a power supply control section 57 that controls power supply to HV integrated ECU 54 and MG-ECU 55.

Verification EUC 52 verifies whether or not a signal from remote key 86 is compatible with the vehicle. Where the verification result indicates compatibility, verification EUC 52 turns ON switch IGCT1 to supply power to HV integrated ECU 54. As a result, HV integrated ECU 54 is started. In this case, the vehicle can be moved through the operation of various operating units within the passenger compartment.

Body ECU 53 detects a vehicle state including the state of an operating unit (start switch, for example) within the passenger compartment, and transmits the detected state to HV integrated ECU 54.

Battery ECU 56 monitors current TB and voltage VB of main battery MB, and detects a battery state including the state of charge SOC and transmits the detected state to HV integrated ECU 54.

HV integrated ECU 54 controls system main relays SMRB, SMRG, and MG-ECU 55, based on the vehicle state transmitted from body ECU 53 and the battery state transmitted from battery ECU 56, for example

MG-ECU 55 controls DC/DC converter 31 as well as inverters 22, 23 and converter 21 illustrated in FIG. 1, under the control of HV integrated ECU 54.

As described above, auxiliary battery AB plays an important role as the power supply for controlling the vehicle. If auxiliary battery AB goes dead, the vehicle cannot be started. Thus, where the system for the vehicle cannot be started after parking for a long time, it is necessary to recover the auxiliary battery in which the amount of stored electric power has decreased due to self-discharge or the like with time.

After a prescribed time set in built-in memory has passed from when the vehicle system is turned OFF through the operation of system start switch 81 or the like illustrated in FIG. 1, timer IC 51 outputs a start command to verification EUC 52.

Verification EUC 52, upon reception of the start command from timer IC, turns ON switch IGCT1 even in the absence of a signal from remote key 86, and provides power supply to HV integrated ECU 54. As a result, HV integrated ECU 54 is started. In this case, HV integrated ECU 54 executes the charge/discharge control by operating system main relays SMRB, SMRG, switch IGCT2, and DC/DC converter 31.

HV integrated ECU 54 can rewrite the setting value stored in the memory of timer IC 51, as required. In this way, where charging is interrupted, for example, the charge/discharge control can be executed so as to prevent auxiliary battery AB from going dead.

It is noted that FIG. 2 illustrates an example of the configuration of control device 50, and various modifications are possible. While control device 50 illustrated in FIG. 2 includes a plurality of ECUs, it may be configured with a smaller number of ECUs by further integration of the ECUs, or conversely, it may be configured with a larger number of ECUs.

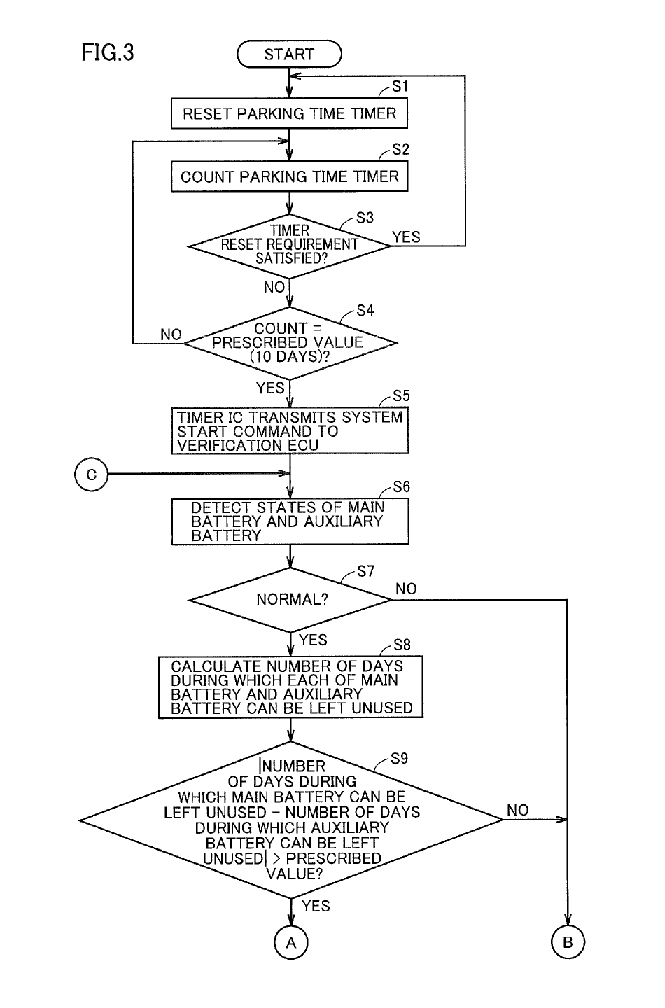

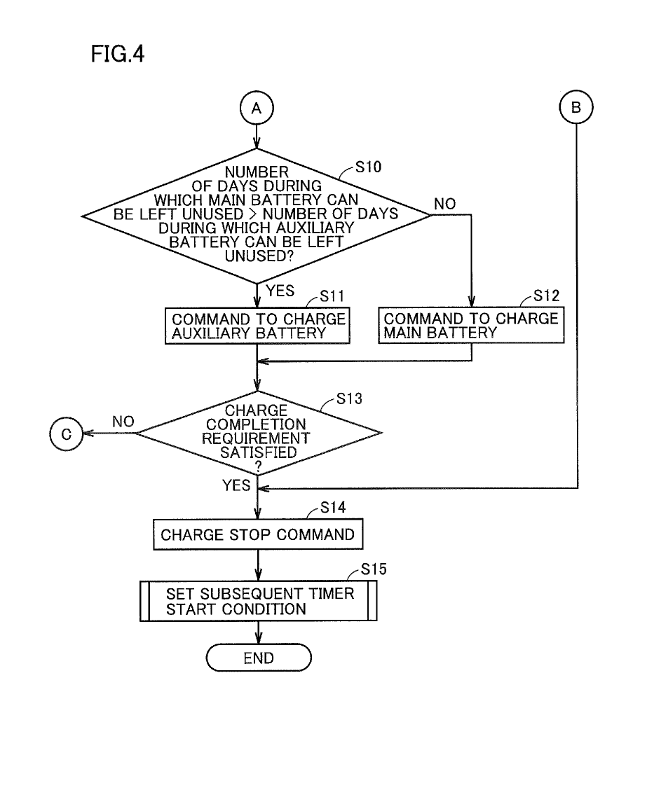

Each of FIGS. 3 and 4 is a flowchart illustrating a processing procedure of the charge/discharge control executed by control device 50 illustrated in FIG. 1. With reference back to FIG. 2 together with FIGS. 3 and 4, when the system start switch is turned OFF by the user (IG OFF), timer IC 51 resets a parking time timer for measuring the parking time (step S1).

Next, timer IC 51 counts the parking time timer (step S2). Timer IC 51 then determines whether a timer reset requirement is satisfied or not (step S3).

The timer reset requirement includes, for example, transition of the vehicle system to the ON (IG ON) state as a result of the operation of system start switch 81 in FIG. 1, and charging of main battery MB with a power supply external to the vehicle. Where it is determined in step S3 that the timer reset requirement is satisfied (YES in step S3), the processing returns to step S1 where the parking time timer of timer IC 51 is reset.

Where it is determined in step S3 that the timer reset requirement is not satisfied (NO in step S3), the processing proceeds to step S4. In step S4, timer IC 51 determines whether the value of the parking time timer being counted (hereinafter referred to as the “count value”) matches (or exceeds) a prescribed value set in the memory (the value corresponding to 10 days, for example) or not. That is, in step S4, it is determined whether the vehicle has been left parked for a prescribed period (10 days, for example) or not.

Where it is determined in step S4 that the count value does not match the prescribed value (does not exceed the prescribed value) (NO in step S4), the processing returns to step S2 where counting of the parking time timer is continued. On the other hand, where it is determined in step S4 that the count value matches the prescribed value (or exceeds the prescribed value) (YES in step S4), the processing proceeds to step S5.

In step S5, timer IC 51 outputs a system start command to verification EUC 52. In response to the system start command, verification EUC 52 causes switches IGCT1 and IGCT2 to be turned ON. This starts HV integrated ECU 54 and MG-ECU 55.

HV integrated ECU 54 then detects a state of each of main battery MB and auxiliary battery AB (step S6). Specifically, HV integrated ECU 54 detects an amount of remaining electric power of each of main battery MB and auxiliary battery AB. It is noted that the amount of remaining electric power can be estimated based on the SOC or the parking time.

HV integrated ECU 54 then determines whether the state of each of main battery MB and auxiliary battery AB is abnormal or not (step S7). Specifically, where the amount of remaining electric power of each of main battery MB and auxiliary battery AB is not within a prescribed range, HV integrated ECU 54 determines that the state of each of main battery MB and auxiliary battery AB is abnormal. Where it is determined in step S7 that the state of each of main battery MB and auxiliary battery AB is abnormal (NO in step S7), HV integrated ECU 54 transmits a command to stop DC/DC converter 31 to MG-ECU 55 (step S14).

Where it is determined in step S7 that the state of at least one of main battery MB and auxiliary battery AB is normal (YES in step S7), HV integrated ECU 54 calculates the number of days during which each of main battery MB and auxiliary battery AB can be left unused (step S8). Specifically, the number of days during which main battery MB can be left unused can be calculated using the following equation:

The number of days during which main battery MB can be left unused=the amount of remaining electric power [Wh] of main battery MB/the amount of self-discharge [Wh/day] (1)

It is noted that the amount of self-discharge has been previously stored in HV integrated ECU 54 as a constant or a map.

The number of days during which auxiliary battery AB can be left unused can be calculated using the following equation:

The number of days during which auxiliary battery AB can be left unused=the amount of remaining electric power [Wh] of auxiliary battery AB/the amount of dark electric power [Wh/day] (2).

It is noted that the amount of dark electric power is stored in HV integrated ECU 54 as a constant based on a previously estimated dark current value.

HV integrated ECU 54 then determines whether a difference between the number of days during which main battery MB can be left unused and the number of days during which auxiliary battery AB can be left unused is greater than a prescribed value or not (step S9). Where it is determined in step S9 that the difference between the number of days during which main battery MB can be left unused and the number of days during which auxiliary battery AB can be left unused is not greater than the prescribed value (NO in step S9), HV integrated ECU 54 transmits a command to stop DC/DC converter 31 to MG-ECU 55 (step S14). This allows a reduction in the number of times that DC/DC converter 31 is activated, leading to a reduction in the power loss caused by DC/DC converter 31.

Where it is determined in step S9 that the difference between the number of days during which main battery MB can be left unused and the number of days during which auxiliary battery AB can be left unused is greater than the prescribed value (YES in step S9), HV integrated ECU 54 determines whether the number of days during which main battery MB can be left unused is greater than the number of days during which auxiliary battery AB can be left unused (step S10). Where it is determined in step S10 that the number of days during which main battery MB can be left unused is greater than the number of days during which auxiliary battery AB can be left unused (YES in step S10), HV integrated ECU 54 outputs a command to MG-ECU55 to cause DC/DC converter 31 to charge auxiliary battery AB with electric power of main battery MB (step S11). Prior to this command, HV integrated ECU 54 turns ON system main relays SMRB, SMRG, which connects main battery MB and DC/DC converter 31.

Where it is determined in step S10 that the number of days during which main battery MB can be left unused is not greater than the number of days during which auxiliary battery AB can be left unused (NO in step S10), HV integrated ECU 54 outputs a command to MG-ECU55 to cause DC/DC converter 31 to charge main battery MB with electric power of auxiliary battery AB (step S12). Prior to this command, HV integrated ECU 54 turns ON system main relays SMRB, SMRG, which connects main battery MB and DC/DC converter 31.

As described above, the charge/discharge control is executed to reduce the difference between the number of days during which main battery MB can be left unused and the number of days during which auxiliary battery AB can be left unused. Consequently, the parking period during which the vehicle can be in a drivable state can be extended.

HV integrated ECU 54 then determines whether a charge completion requirement is satisfied or not (step S13). The charge completion requirement corresponds to, for example, the case where any of the doors of the vehicle is opened, the case where the charge/discharge time has lasted for a prescribed time (10 minutes, for example) or longer, or the case where the SOC of main battery MB or auxiliary battery AB has decreased below a prescribed value. As used herein, the prescribed time (10 minutes, for example) is determined in connection with the prescribed value (the value corresponding to 10 days, for example) in step S4. For example, when 10 minutes is a sufficient time to charge an amount of self-discharge for 10 days, the prescribed time (10 minutes) is determined for the prescribed value (10 days).

While the case where a door is opened has been described as an example of the charge completion requirement, other charge completion requirements may include, for example, the cases where the engine hood is opened, a door lock is released, the brake pedal is depressed, the auto-alarm system is set in an alarmed state, and the remote key is detected. In any of these cases, it is expected that the user is touching the vehicle, is near the vehicle, or will approach the vehicle due to the alarm operation, and hence, the possibility that the vehicle system will be started by the user is considered to be high. With these charge completion requirements, the charge/discharge control can be safely executed.

Where it is determined in step S13 that the charge completion requirement is satisfied (YES in step S13), the processing proceeds to step S14, while it is determined in step S13 that the charge completion requirement is not satisfied (NO in step S13), the processing returns to step S6 where the charge/discharge control is continued.

In step S14, HV integrated ECU 54 transmits a command to stop DC/DC converter 31 to MG-ECU 55.

Next, in step S15, processing for setting a subsequent timer start condition is executed. Specifically, if charge and discharge is interrupted, or if charge and discharge is not started, timing of starting the subsequent charge/discharge processing is set so as to prevent main battery MB or auxiliary battery AB from going dead as much as possible. At the completion of the setting processing in step S15, the processing in accordance with the flowchart in FIGS. 3 and 4 ends.

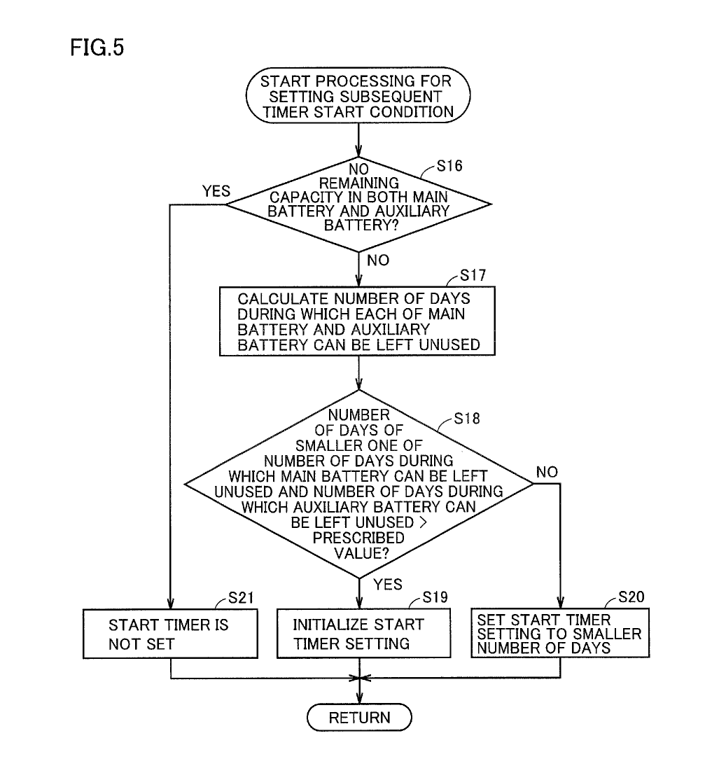

FIG. 5 is a flowchart for illustrating details of the processing for setting a timer start condition in step S15 in FIG. 4. In accordance with the processing shown in this flowchart, if charge and discharge is interrupted, timing of starting the subsequent charge and discharge is set so as to prevent main battery MB or auxiliary battery AB from going dead as much as possible.

With reference back to FIG. 2 together with FIG. 5, HV integrated ECU 54 determines in step S16 whether there is no remaining capacity in both main battery MB and auxiliary battery AB or not. Where it is determined in step S16 that there is no remaining capacity in both main battery MB and auxiliary battery AB (YES in step S16), HV integrated ECU 54 does not set the start timer (step S21).

Where it is determined in step S16 that there is a remaining capacity in at least one of main battery MB and auxiliary battery AB (NO in step S16), HV integrated ECU 54 calculates the number of days during which each of main battery MB and auxiliary battery AB can be left unused, as in step S8 (step S17).

HV integrated ECU 54 then determines whether the smaller one of the number of days during which main battery MB can be left unused and the number of days during which auxiliary battery AB can be left unused is greater than a prescribed value or not (step S18). Where it is determined in step S18 that the smaller one of the number of days during which main battery MB can be left unused and the number of days during which auxiliary battery AB can be left unused is greater than the prescribed value (YES in step S18), HV integrated ECU 54 initializes a start timer setting (step S19). Specifically, the prescribed value used in step S4 in FIG. 3 is set as an initial value (10 days, for example). Thus, so long as the numbers of days during which the batteries can be left unused are greater than the prescribed value, charge and discharge is executed at an interval corresponding to the prescribed value (10 days, for example).

Where it is determined in step S18 that the smaller one of the number of days during which main battery MB can be left unused and the number of days during which auxiliary battery AB can be left unused is not greater than the prescribed value (NO in step S18), HV integrated ECU 54 sets the start timer setting to be the number of days corresponding to the smaller one of the number of days during which main battery MB can be left unused and the number of days during which auxiliary battery AB can be left unused. This allows the subsequent charge/discharge control to be started before any of main battery MB and auxiliary battery AB goes dead.

As described above, in this embodiment, after a predetermined time has passed from the input of a stop command for the power supply system for the vehicle, the charge/discharge control is executed to cause one of main battery MB and auxiliary battery AB to be charged and the other of main battery MB and auxiliary battery AB to be discharged by DC/DC converter 31, based on a result of comparison between the number of days during which main battery MB can be left unused and the number of days during which auxiliary battery AB can be left unused. In this way, the distribution of electric power stored in main battery MB and auxiliary battery AB is adjusted, which allows only one of main battery MB and auxiliary battery AB to be prevented from going dead. According to this embodiment, therefore, in a vehicle on which the power supply system including main battery MB and auxiliary battery AB is mounted, the parking time during which the vehicle can be in a drivable state can be extended.

Furthermore, in this embodiment, the charge/discharge control is executed by comparing the number of days during which main battery MB can be left unused and the number of days during which auxiliary battery AB can be left unused. Consequently, even if main battery MB and auxiliary battery AB have different capacities, the same parameter can be used for the comparison.

Furthermore, in this embodiment, the charge/discharge control is completed when the difference between the number of days during which main battery MB can be left unused and the number of days during which auxiliary battery AB can be left unused falls below a predetermined value. This allows a reduction in the number of times that DC/DC converter 31 is activated, leading to a reduction in the power loss caused by DC/DC converter 31.

Furthermore, in this embodiment, charge and discharge is completed when the charge completion requirement is satisfied. This allows the charge/discharge control to be safely executed.

Furthermore, in this embodiment, when the charge/discharge control is interrupted, the number of days during which each of main battery MB and auxiliary battery AB can be left unused is calculated, and based on a result of comparison between the predetermined period and the number of days during which each of main battery MB and auxiliary battery AB can be left unused, the start time for the charge/discharge control is set so as to prevent main battery MB and auxiliary battery AB from going dead until the charge/discharge control takes place next time. This allows the subsequent charge/discharge control to be started before any of main battery MB and auxiliary battery AB goes dead.

While the foregoing describes the vehicle as a hybrid vehicle on which engine 2 is mounted, the scope of applications of this invention is not limited to the hybrid vehicle as described above, but also includes an electric vehicle without an engine, a fuel-cell vehicle on which a fuel cell is additionally mounted as an energy source, and the like.

Furthermore, while the foregoing describes the comparison between the number of days during which main battery MB can be left unused and the number of days during which auxiliary battery AB can be left unused, a parameter representing the length during which each of main battery MB and auxiliary battery AB can be left unused may be used, instead of the number of days during which each battery can be left unused. Alternatively, instead of the number of days during which each battery can be left unused, a state amount representing the charged state of each of main battery MB and auxiliary battery AB may be used. The state amount representing the charged state of each of main battery MB and auxiliary battery AB is, for example, the SOC of each of main battery MB and auxiliary battery AB, or a value such as a voltage value or the like from which the capacity of the battery can be measured.

In the foregoing description, main battery MB corresponds to an embodiment of the “first power storage device” according to this invention, and auxiliary battery AB corresponds to an embodiment of the “second power storage device” according to this invention. DC/DC converter 31 corresponds to an embodiment of the “converter” according to this invention.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

2: engine; 4: power split device; 6: wheel; 20: PCU; 21: converter; 22, 23: inverter; 30: auxiliary load; 31: DC/DC converter; 44: connector; 50: control device; 51: timer IC; 52: verification EUC; 53: body ECU; 54: integrated ECU; 55: MG-ECU; 56: battery ECU; 57: power supply control section; 61: voltage sensor; 62: current sensor; 71: sensor section; 81: system start switch; 82: door opening/closing detection sensor; 83: engine hood opening/closing detection sensor; 84: brake pedal stroke sensor; 85: auto-alarm system; 86: remote key; 100: vehicle; MB: main battery; AB: auxiliary battery; C1, C2: capacitor; IGCT1, IGCT2: switch; MG1, MG2: motor generator; SMRB, SMRG: system main relay.

1. A power supply system for a vehicle comprising:
a first power storage device that stores electric power for running;
a second power storage device that stores electric power to be supplied to an auxiliary load of said vehicle;
a converter configured to be capable of executing bidirectional power conversion between said first power storage device and said second power storage device; and
a control device configured to execute charge/discharge control, after a predetermined time has passed from input of a stop command for said power supply system, to cause one of said first power storage device and said second power storage device to be charged and the other of said first power storage device and said second power storage device to be discharged by said converter, based on a result of comparison between a charged state of said first power storage device and a charged state of said second power storage device.

2. The power supply system for a vehicle according to claim 1, wherein
during the execution of said charge/discharge control, said control device controls said converter to reduce a difference between a state amount representing the charged state of said first power storage device and a state amount representing the charged state of said second power storage device.

3. The power supply system for a vehicle according to claim 1, wherein
the charged state of said first power storage device corresponds to a period during which said first power storage device can be left unused, depending on the state amount representing the charged state of said first power storage device, and
the charged state of said second power storage device corresponds to a period during which said second power storage device can be left unused, depending on the state amount representing the charged state of said second power storage device.

4. The power supply system for a vehicle according to claim 1, wherein
said control device completes said charge/discharge control when the difference between the state amount representing the charged state of said first power storage device and the state amount representing the charged state of said second power storage device falls below a predetermined value.

5. The power supply system for a vehicle according to claim 1, wherein
during the execution of said charge/discharge control, said control device interrupts said charge/discharge control when a prescribed condition is satisfied.

6. The power supply system for a vehicle according to claim 5, wherein
said prescribed condition is satisfied when at least one of opening of a door, opening of an engine hood, release of a door lock, depression of a brake pedal, an auto-alarm system being set in an alarmed state, and approaching of a remote key, is detected.

7. The power supply system for a vehicle according to claim 5, wherein
when said charge/discharge control is interrupted, said control device calculates the period during which said first power storage device can be left unused and the period during which said second power storage device can be left unused, and based on a result of comparison between said predetermined period and each of the period during which said first power storage device can be left unused and the period during which said second power storage device can be left unused, said control device sets a start time for said charge/discharge control, so as to prevent electric power stored in said first power storage device and electric power stored in said second power storage device from running out until said charge/discharge control takes place next time.

8. A vehicle comprising the power supply system according to claim 1.

9. A method for controlling a power supply system for a vehicle,
said power supply system including:
a first power storage device that stores electric power for running;
a second power storage device that stores electric power to be supplied to an auxiliary load of said vehicle; and
a converter configured to be capable of executing bidirectional power conversion between said first power storage device and said second power storage device,
said method including the step of:
executing charge/discharge control, after a predetermined time has passed from input of a stop command for said power supply system, to cause one of said first power storage device and said second power storage device to be charged and the other of said first power storage device and said second power storage device to be discharged by said converter, based on a result of comparison between a charged state of said first power storage device and a charged state of said second power storage device.

10. The method for controlling the power supply system for a vehicle according to claim 9, wherein
the step of executing said charge/discharge control includes the step of, during the execution of said charge/discharge control, controlling said converter to reduce a difference between a state amount representing the charged state of said first power storage device and a state amount representing the charged state of said second power storage device.

11. The method for controlling the power supply system for a vehicle according to claim 9, wherein
the charged state of said first power storage device corresponds to a period during which said first power storage device can be left unused, depending on the state amount representing the charged state of said first power storage device, and
the charged state of said second power storage device corresponds to a period during which said second power storage device can be left unused, depending on the state amount representing the charged state of said second power storage device.

12. The method for controlling the power supply system for a vehicle according to claim 9, wherein
the step of executing said charge/discharge control includes the step of completing said charge/discharge control when the difference between the state amount representing the charged state of said first power storage device and the state amount representing the charged state of said second power storage device falls below a predetermined value.

13. The method for controlling the power supply system for a vehicle according to claim 9, wherein
the step of executing said charge/discharge control includes the step of, during the execution of said charge/discharge control, interrupting said charge/discharge control when a prescribed condition is satisfied.

14. The method for controlling the power supply system for a vehicle according to claim 13, wherein
said prescribed condition is satisfied when at least one of opening of a door, opening of an engine hood, release of a door lock, depression of a brake pedal, an auto-alarm system being set in an alarmed state, and approaching of a remote key, is detected.

15. The method for controlling the power supply system for a vehicle according to claim 13, wherein
the step of executing said charge/discharge control includes the steps of:
when said charge/discharge control is interrupted, calculating the period during which said first power storage device can be left unused and the period during which said second power storage device can be left unused; and
based on a result of comparison between said predetermined period and each of the period during which said first power storage device can be left unused and the period during which said second power storage device can be left unused, setting a start time for said charge/discharge control, so as to prevent electric power stored in said first power storage device and electric power stored in said second power storage device from running out until said charge/discharge control takes place next time.

16. The power supply system for a vehicle according to claim 2, wherein
the charged state of said first power storage device corresponds to a period during which said first power storage device can be left unused, depending on the state amount representing the charged state of said first power storage device, and
the charged state of said second power storage device corresponds to a period during which said second power storage device can be left unused, depending on the state amount representing the charged state of said second power storage device.

17. The power supply system for a vehicle according to claim 6, wherein
when said charge/discharge control is interrupted, said control device calculates the period during which said first power storage device can be left unused and the period during which said second power storage device can be left unused, and based on a result of comparison between said predetermined period and each of the period during which said first power storage device can be left unused and the period during which said second power storage device can be left unused, said control device sets a start time for said charge/discharge control, so as to prevent electric power stored in said first power storage device and electric power stored in said second power storage device from running out until said charge/discharge control takes place next time.

18. The method for controlling the power supply system for a vehicle according to claim 10, wherein
the charged state of said first power storage device corresponds to a period during which said first power storage device can be left unused, depending on the state amount representing the charged state of said first power storage device, and
the charged state of said second power storage device corresponds to a period during which said second power storage device can be left unused, depending on the state amount representing the charged state of said second power storage device.

19. The method for controlling the power supply system for a vehicle according to claim 14, wherein
the step of executing said charge/discharge control includes the steps of:
when said charge/discharge control is interrupted, calculating the period during which said first power storage device can be left unused and the period during which said second power storage device can be left unused; and
based on a result of comparison between said predetermined period and each of the period during which said first power storage device can be left unused and the period during which said second power storage device can be left unused, setting a start time for said charge/discharge control, so as to prevent electric power stored in said first power storage device and electric power stored in said second power storage device from running out until said charge/discharge control takes place next time.
